(19) United States
(12) Patent Application Publication
(10) Pub. No.: US 2020/0170428 A1
(43) Pub. Date: Jun. 4, 2020

(54) FLATWARE STRUCTURED TO AVOID TABLE CONTACT

(71) Applicant: TIM STEVENSON, GILBERT, AZ (US)

(72) Inventor: TIM STEVENSON, GILBERT, AZ (US)

(21) Appl. No.: 16/783,958

(22) Filed: Feb. 6, 2020

Related U.S. Application Data
(63) Continuation-in-part of application No. 15/939,193, filed on Mar. 28, 2018.

(51) Int. Cl. A47G 21/02; A47G 21/04; B26B 3/02

(52) U.S. Cl. CPC A47G 21/02; A47G 21/023; A47G 2400/025; B26B 3/02; A47G 21/04

(57) ABSTRACT

An eating utensil has a handle and a food handling portion connected to the handle. A stand elevates the food handling portion above a substantially flat surface. The stand has a pair of flap members, wherein each flap member extends down and away from the handle. Each flap sized to allow a user to apply pressure on an edge of the handle.

### RELATED APPLICATIONS

This patent application is a Continuation-In-Part of U.S. patent application Ser. No. 15/939,193 filed Mar. 28, 2018, entitled “FLATWARE STRUCTURED TO AVOID TABLE CONTACT” in the name of Tim Stevenson, and which is incorporated herein by reference in its entirety.

### TECHNICAL FIELD

The present invention generally relates to utensils and, more specifically to, eating utensils that avoid the food-handling portion from touching a table surface that may be contaminated and to provide an area for applying pressure on the eating utensil when using the eating utensil for cutting food.

### BACKGROUND

Conventional eating utensils such as forks, spoons, and knives (flatware) provide a useful way to avoid hand contact with food. Such eating utensils are designed such that only the non-handle portion of the eating utensil comes into contact with the food. This is beneficial since the surface of the human hand may include harmful bacteria and other pathogens.

However, conventional flatware can immediately become contaminated once placed onto a table surface. According to several recent studies, table surfaces, particularly in restaurants, frequently contain unhealthy microorganisms including bacteria and viruses. Although restaurants are required to wipe tabletops before each use, the cloths and sponges used to do so are often not clean.

Many individuals use forks and/or spoons to cut food items. In doing so, these individuals may rotate the fork so that an outer tine of the fork and/or the outer edge of the bowl of the spoon may be used to cut the food item. In order to cut the food item, the individual may need to apply pressure on the handle of the fork and/or spoon. However, rotating the utensil may cause the individual to apply pressure to the narrow edge of the handle of the utensil and not the wider flat portion of the handle. For some food items that may be harder to cut, the individual may have to apply a larger amount of pressure on the edge of the utensil. This may cause a certain amount of discomfort to the individual.

Therefore, it would be desirable to provide a device and method that overcome the above problems. The device and method would allow an individual to rotate the utensil to cut a food item by applying pressure to the narrow edge of the handle limiting the discomfort to the individual.

### SUMMARY

In accordance with one embodiment, an eating utensil is disclosed. The eating utensil has a handle. A food handling portion is connected to the handle. A stand elevates the food handling portion above a substantially flat surface. The stand comprises a pair of flap members. Each flap member is coupled to a neck area of the eating utensil where the handle connects to the food handling portion. Each flap member extends down and away from the handle. Each flap member is sized to fit a tip of a finger of a user.

In accordance with one embodiment, an eating utensil is disclosed. The eating utensil has a handle. A food handling portion is connected to the handle. A stand elevates the food handling portion above a substantially flat surface. The stand comprises a pair of flap members. Each flap member is coupled to a neck area of the eating utensil where the handle connects to the food handling portion. Each flap member extends down and away from the handle. Each flap member is sized to allow a user to apply pressure on an edge of the handle.

In accordance with one embodiment, an eating utensil is disclosed. The eating utensil has a handle. A food handling portion is connected to the handle. A stand elevates the food handling portion above a substantially flat surface. The stand comprises a pair of semicircular flap members. Each semicircular flap member is coupled to a neck area of the eating utensil where the handle connects to the food handling portion. Each semicircular flap member extends down and away from the handle at an angle between 30° to 45°. Each semicircular flap member is sized to allow a tip of an extremity of a user to fit on a respective semicircular flap member to apply pressure on an edge of the handle.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 illustrates a top view of an exemplary set of eating utensils structured to avoid touching a surface, according to one embodiment of the present invention;

FIG. 2 illustrates a perspective view of the set of eating utensils of FIG. 1, according to one embodiment of the present invention;

FIG. 3 illustrates a side view of the exemplary fork of FIG. 1 having a structure to avoid touching a surface, according to one embodiment of the present invention;

FIGS. 4A-D are different close-up views of the exemplary fork of FIG. 1, in various different perspectives, according to one embodiment of the present invention;

FIG. 5 illustrates side views of an exemplary spoon and an exemplary knife of FIG. 1, respectively, having a structure to avoid touching a surface, according to one embodiment of the present invention;

FIG. 6. illustrates a perspective views of the fork of FIG. 1 being used to cut food, showing that the stand can dually function as an aid in cutting food, according to one embodiment of the present invention; and

FIG. 7 illustrates the exemplary set of eating utensils of FIG. 1 in a stacked arrangement, according to one embodiment of the present invention.

### DESCRIPTION OF THE APPLICATION

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

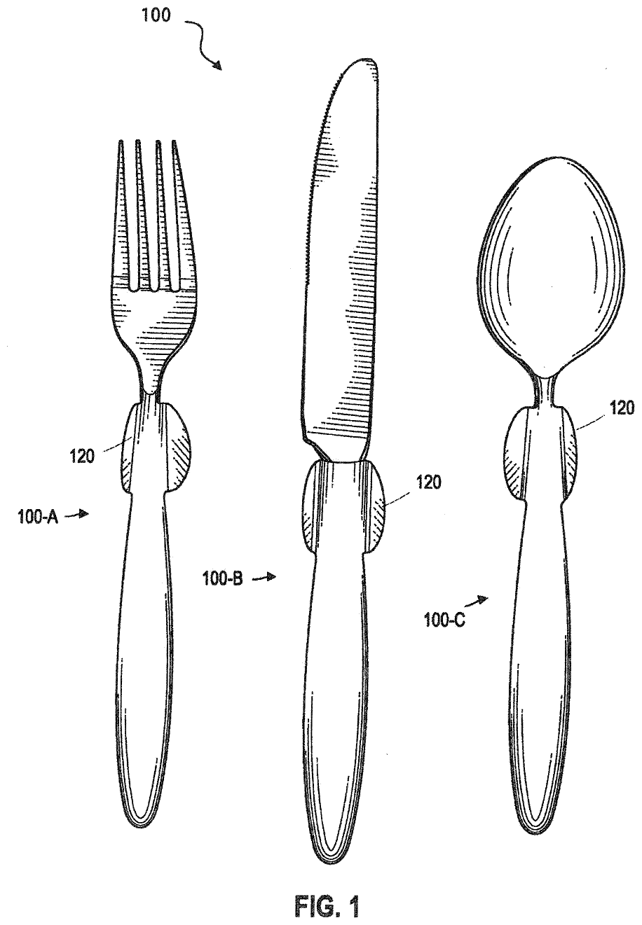

Referring to FIG. 1, a top view of an exemplary set of eating utensils (flatware) 100 structured to avoid touching a surface, such as a tabletop, according to an embodiment, is illustrated. As shown, the set of eating utensils 100 includes a fork 100-A, a knife 100-B, and a spoon 100-C, each of the which include a stand 120. As will be described in greater detail, the stand 120 elevates the food-handling portion so as to avoid direct contact with a potentially contaminated surface, such as a table surface. The eating utensil 100 can be made of various materials, such as stainless steel or silver. In an embodiment, the eating utensil 100 is a plastic disposable eating utensil. It is to be understood, however, that the present invention is not limited to the set of eating instruments 100 shown herein. It is to be appreciated that that the stand 120 may be attached any suitable eating utensil 100 for the purpose of avoiding contact with a potentially contaminated surface.

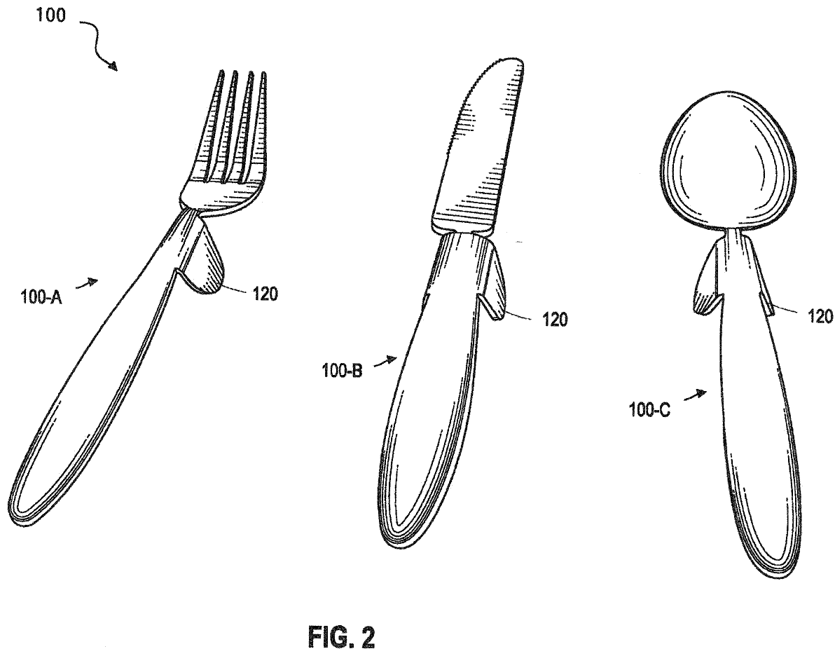

FIG. 2 illustrates a perspective view of the set of eating utensils 100.

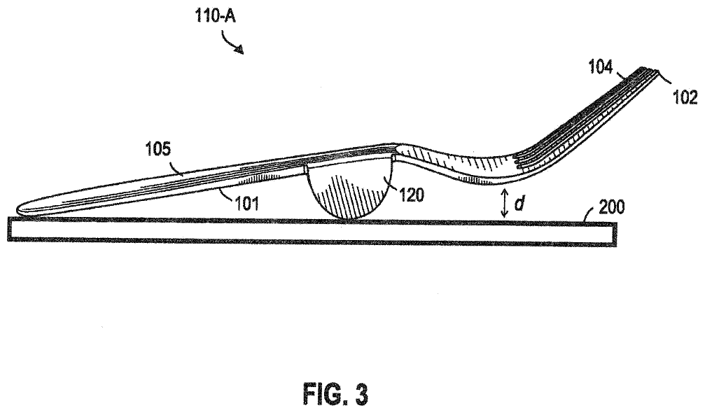

FIG. 3 illustrates a side view of the fork 100-A having a structure to avoid touching a surface 200, according to an embodiment. As shown, the surface 200 is a relatively flat surface such as a table surface, a tray, or a storage shelf. Harmful bacteria, viruses, and so forth may lurk on the surface 200. The fork 100-A includes a handle 105, a food-handling portion 104, and a stand 120. The handle 105 and the food-handling portion 104 are connected to each other, as shown (and may be formed in the same mold). The stand 120 extends downwardly beyond a bottom surface 101 (in an opposite direction from which the fork prongs 102 are pointing). As shown, the stand 120 is placed proximate a neck area 103 of the fork 100-A where the handle 105 connects to the food-handling portion 104. The stand 120 raises the food-handling portion 104 of the fork 100-A a distance d. In an embodiment, the stand 120 is about 1-3 cm in height, raising the food-handling portion 104 about 1-3 cm above the surface 200.

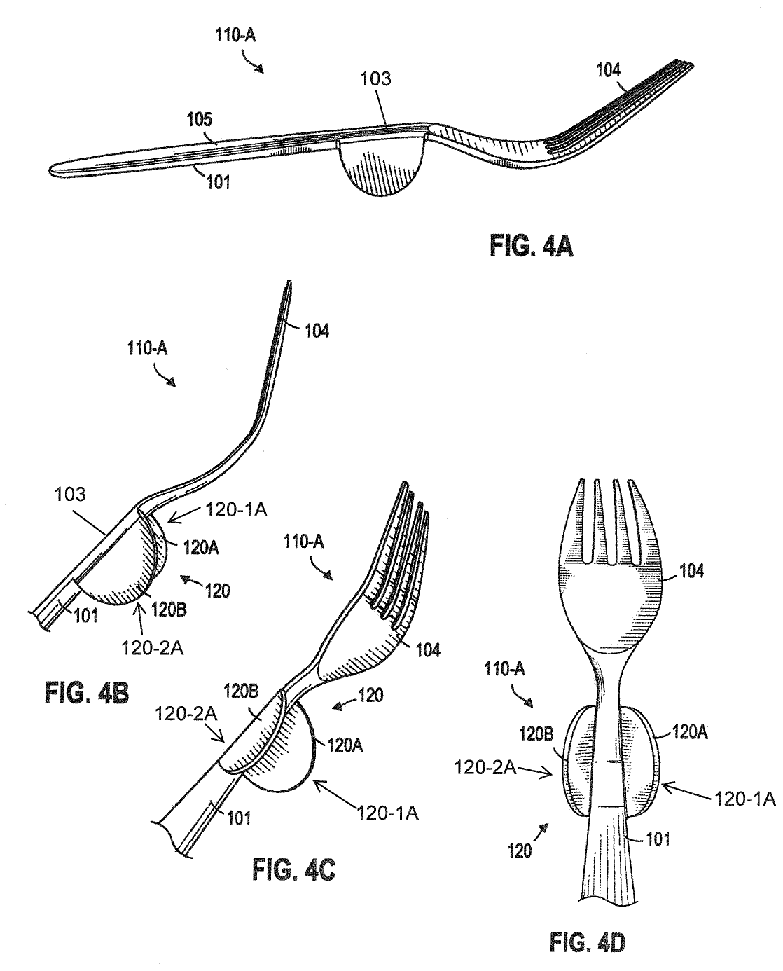

FIGS. 4A-D illustrate close-up views of the fork 100-A showing the stand 120, in various different perspectives. FIG. 4A shows a side view of the fork 100-A. FIGS. 4B and 4C show side perspective views, as the fork 100-A is rotated counter-clockwise. FIG. 4D shows the stand 120 from the bottom of the fork 100-A. As shown, the stand 120 is a double-legged stand that includes a first leg 120-1 and second leg 120-2, which are substantially identical. The first leg 120-1 and second leg 120-2 may be attached to a neck area 103 of the fork 100-A where the handle 105 connects to the food-handling portion 104.

The first leg 120-1 and the second leg 120-2 extend outwardly and downwardly at an acute angle (e.g., about 30-45 degrees) from a center line of the fork 100-A. Although the legs 120-1 and 120-2 have rounded edges, it is to be understood that a different shape may suffice. For example, the legs 120-1 and 120-2 could have substantially flat bottom surfaces.

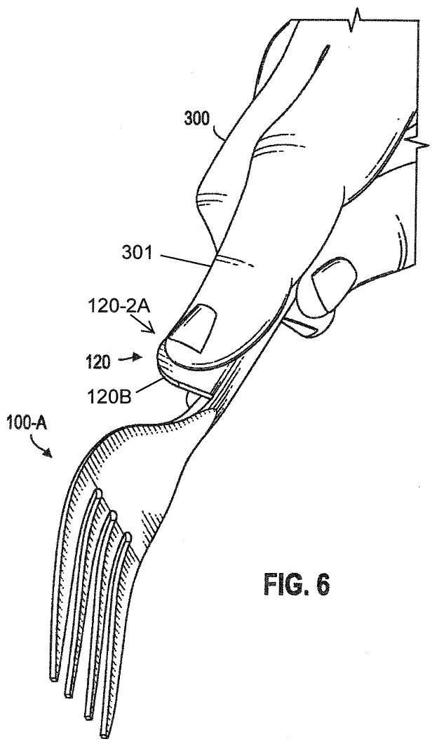

The first leg 120-1 and second leg 120-2, may be flap members 120-1A and 120-2A. In the present embodiment, the flap members 120-1A and 120-2A may be semi-circular in shape. However, the flap members 120-1A and 120-2A may come in other shapes such as rectangular, square, or other like configurations. The flap members 120-1A and 120-2A may be attached to the neck area 103 of the fork 100-A where the handle 105 connects to the food-handling portion 104. The flap members 120-1A and 120-2A may be sized to allow an index finger 301 (FIG. 6) of a hand 300 (FIG. 6) to be comfortable placed thereon when the fork 100-A may be used to cut a food item as shown in FIG. 6. In accordance with one embodiment, the flap members 120-1A and 120-2A may have an area of approximately 3-5 cm². The flap members 120-1A and 120-2A are substantially identical in shape and size. The flaps 120-1A and 120-2A extend outwardly and downwardly at an acute angle (e.g., about 30-45 degrees) from a center line of the fork 100-A.

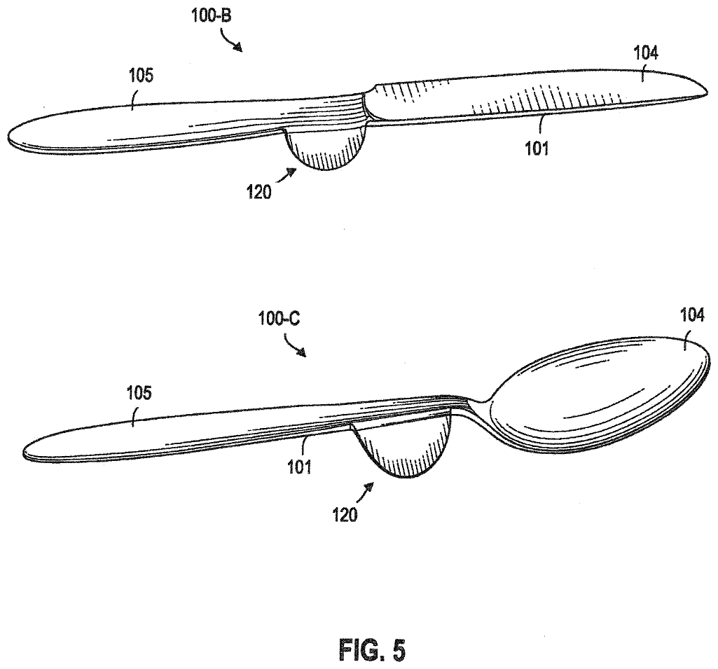

FIG. 5 illustrates side views of the spoon 100-B and the knife 100-C, respectively, having a structure to avoid touching a surface, according to an embodiment. It is to be understood that although the fork 100-A has been primarily used to illustrate the present invention, each of the other eating instruments 100, such as the knife 100-C and the spoon 100-B, are similarly structured. That is to say, the main difference among the eating utensils 100 resides with the food-handling portions 104 thereof. The stand 120 for each is substantially the same.

FIG. 6 illustrates a perspective view of the fork 100-A being used to cut food as disclosed above. As shown, the stand 120 can dually function to provide a more stable and less stressful way to cut food items (e.g., waffles, French toast, etc.) with the side of the fork 100-A. As shown, a person holds the fork 100-A in their hand 300 by grasping the handle 105 and uses the index finger 301 to control the movement and apply pressure to one of the flap members 120-1A or 120-2A of the fork 100-A. As shown in FIG. 6, the position of the flap member 120-1A or 120-2A allows the user to rotate the fork 100-A and use the food-handling portion 104 to cut the food item by using the index finger 301 to control the movement and apply pressure to one of the flap members 120-1A or 120-2A of the fork 100-A. The flap members 120-1A and 120-2A may be sized to allow a majority if not the entire tip of the index finger 301 to be positioned on the flap member 120-1A or 120-2A to control the movement and apply pressure. The result is less strain and better control to get the fork 100-A through the food item without the necessity of employing a knife. Furthermore, the fork 100-A can achieve the same result whether used in the right hand or left hand.

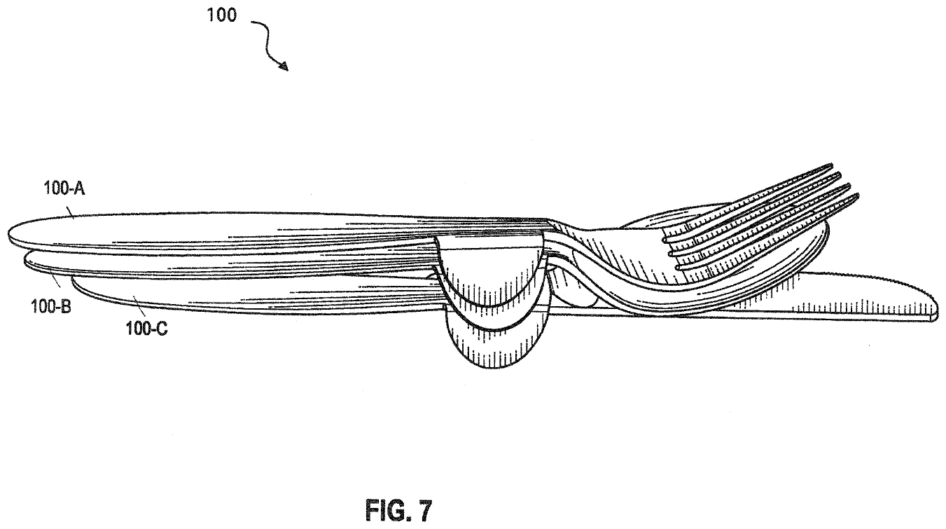

FIG. 7 illustrates the exemplary set of eating utensils 100 in a stacked arrangement, according to an embodiment. One of the advantages to the use of a double-legged stand, as disclosed herein, is that such a structure permits each of the eating utensils in the set of eating utensils 100 to be easily stacked. This is advantageous since it reduces storage space, and allows for a sanitary way to place the flatware on a tabletop prior to usage.

The eating utensil 100 uses a stand 120 that is attached to a neck area 103 of the eating utensil 100 where the handle 105 connects to the food-handling portion 104. The stand 120 prevents the food-handling portion 104 from touching a table surface that may be contaminated and to provide an area for applying pressure on the eating utensil 100 when using the eating utensil for cutting food. The position of the stand 120 allows one to grip the handle 105 without touching the stand 120 during normal use of the eating utensil 100. The position of the stand 120 further allows the user to rotate the eating utensil 100 and use the food-handling portion 104 to cut the food item by using the index finger 301 to control the movement and apply pressure to one of the flap members 120-1A or 120-2A of the stand 120.

While embodiments of the disclosure have been described in terms of various specific embodiments, those skilled in the art will recognize that the embodiments of the disclosure may be practiced with modifications within the spirit and scope of the claims.

What is claimed is:

1. An eating utensil, comprising:
a handle;
a food handling portion connected to the handle; and
a stand elevating the food handling portion above a substantially flat surface, wherein the stand comprises:
a pair of flap members, each flap member coupled to a neck area of the eating utensil where the handle connects to the food handling portion, wherein each flap member extends down and away from the handle, each flap member having an area to fit a tip of a finger of a user.

2. The eating utensil of claim 1, wherein each flap extends down and away from the handle at an acute angle.

3. The eating utensil of claim 1, wherein each flap extends down and away from the handle at an angle between 30° to 45°.

4. The eating utensil of claim 1, wherein each flap is semi-circular in shape.

5. The eating utensil of claim 1, wherein the eating utensil is a fork.

6. The eating utensil of claim 1, wherein the eating utensil is a spoon.

7. The eating utensil of claim 1, wherein the eating utensil is a knife.

8. An eating utensil, comprising:
a handle;
a food handling portion connected to the handle; and
a stand elevating the food handling portion above a substantially flat surface, wherein the stand comprises:
a pair of flap members, each flap member coupled to a neck area of the eating utensil where the handle connects to the food handling portion, each flap member extends down and away from the handle, each flap sized to allow a user to apply pressure on an edge of the handle.

9. The eating utensil of claim 8, wherein the pair of flaps are semicircular in shape.

10. The eating utensil of claim 8, wherein the pair of flaps each has an area of 3-4 cm²

11. The eating utensil of claim 8, wherein each flap extends down and away from the handle at an acute angle.

12. The eating utensil of claim 8, wherein each flap extends down and away from the handle at an angle between 30° to 45°.

13. The eating utensil of claim 8, wherein each flap is semi-circular in shape.

14. The eating utensil of claim 8, wherein the eating utensil is a fork.

15. The eating utensil of claim 8, wherein the eating utensil is a spoon.

16. The eating utensil of claim 8, wherein the eating utensil is a knife.

17. An eating utensil, comprising:
a handle;
a food handling portion connected to the handle; and
a stand elevating the food handling portion above a substantially flat surface, wherein the stand comprises:
a pair of semicircular flap members, wherein each semicircular flap member is coupled to a neck area of the eating utensil where the handle connects to the food handling portion, each semicircular flap member extends down and away from the handle at an angle between 30° to 45°, each semicircular flap member is sized to allow a tip of an extremity of a user to fit on a respective semicircular flap member and apply pressure on an edge of the handle.

18. The eating utensil of claim 17, wherein the pair of flaps each has an area of 3-4 cm²

19. The eating utensil of claim 17, wherein the eating utensil is one of a fork, a spoon or a knife.
